(19) United States
(12) Patent Application Publication
(10) Pub. No.: US 2021/0046836 A1
(43) Pub. Date: Feb. 18, 2021

(54) INDUCTIVE CHARGING DEVICE

(71) Applicant: Mahle International GmbH

(72) Inventors: Christopher Laemmle, Stuttgart (DE); Timo Laemmle, Kernen (DE)

(73) Assignees: Mahle International GmbH, Stuttgart (DE); Mahle International GmbH, Stuttgart (DE)

(21) Appl. No.: 16/967,406

(22) PCT Filed: Jan. 31, 2019
(86) PCT No.: PCT/EP2019/052433

§ 371 Date: Aug. 4, 2020

(30) Foreign Application Priority Data
Feb. 5, 2018 (DE) 102018201704.2

(51) Int. Cl. B60L 53/302; H02J 7/04; H02J 50/12; B60L 53/12; B60H 1/00; B60H 1/14

(52) U.S. Cl. CPC B60L 53/302; H02J 7/04; H02J 50/12; H02J 2207/20; B60H 1/00257; B60H 1/143; B60L 53/12

(57) ABSTRACT

An inductive charging device for a partially or fully electrically operated motor vehicle is disclosed. The inductive charging device includes a temperature control arrangement including at least one fluid tube, and a charging arrangement including a charging coil and a battery. The charging coil is arranged in a heat-transmitting manner on the at least one fluid tube, such that waste heat generated in the charging coil is transferred to the fluid in the at least one fluid tube. In a charging state of the charging arrangement, the charging coil is inductively coupled with an external primary coil, and in the charging coil an induction alternating current flows, via which the battery is charged. The charging arrangement can be switched to a heating state where the charging coil is connected to the battery in a current-conducting manner and a heating direct current flows in the charging coil.

### CROSS-REFERENCE TO RELATED APPLICATIONS

This application claims priority to International Patent Application No. PCT/EP2019/052433 filed Jan. 31, 2019, and to German Patent Application No. DE 10 2018 201 704.2 filed Feb. 5, 2018, the contents of each of which are hereby incorporated by reference in their entirety.

### TECHNICAL FIELD

The invention relates to an inductive charging device for a partially or fully electrically operated motor vehicle.

### BACKGROUND

Inductive charging devices are already known from the prior art and are used for the contactless charging of a battery in a motor vehicle. Here, an external primary coil is inductively coupled to a secondary coil in the motor vehicle. An alternating current flows through the primary coil, which alternating current generates an electromagnetic alternating field around the primary coil. In the secondary coil, the electromagnetic alternating field induces an alternating current which is rectified by the power electronics and is delivered to the battery.

During charging, a waste heat is generated in the primary coil and in the secondary coil through energy losses. In particular, the waste heat generated in the secondary coil can damage the power electronics in the inductive charging device and must be dissipated to the exterior. For this, a cooling arrangement, through which a cooling fluid can flow, can be arranged on the secondary coil, as is described for example in U.S. Pat. No. 8,917,511 B2. The cooling arrangement is arranged here in a heat-transmitting manner on the secondary coil, so that the waste heat which is generated in the secondary coil is transferred to the cooling fluid.

The heat which is stored in the cooling fluid can then be dissipated to the environment or can be used for heating a lubricant in the motor vehicle, as is proposed for example in DE 10 2011 088 112 A1. Disadvantageously, the motor vehicle is not in operation during the charging, so that the generated waste heat is not usable and is dissipated to the environment. Furthermore, the amount of waste heat which is generated during charging is relatively small due to small currents and high voltages.

### SUMMARY

The object of the invention is to indicate, for an inductive charging device of the generic type, an improved or at least alternative embodiment, in which the waste heat of the inductive charging device can be generated and used during and also after charging during operation of the motor vehicle.

This problem is solved according to the invention by the subject of the independent claim(s). Advantageous embodiments are the subject of the dependent claims.

The present invention is based on the general idea of generating and using the waste heat of an inductive charging device for a partially or fully electrically operated motor vehicle during and also after charging. The inductive charging device comprises here a temperature control arrangement having at least one fluid tube through which fluid can flow, and a charging arrangement with a charging coil and with a battery. Here, the charging coil is arranged on the at least one fluid tube of the temperature control arrangement in a heat-transmitting manner, so that the heat which is generated in the charging coil can be transferred to the fluid in the at least one fluid tube of the temperature control arrangement. In a charging state of the charging arrangement, the charging coil can be inductively coupled to an external primary coil. In the charging coil an induction alternating current then flows, by means of which the battery of the charging arrangement can be charged. According to the invention, the charging arrangement can be switched to a heating state, wherein in the heating state the charging coil is connected to the battery in a current-conducting manner. In the heating state, a heating direct current flows in the charging coil and the charging coil forms a resistance heating body. The heat generated in the charging coil can be transferred here to the fluid in the at least one fluid tube of the temperature control arrangement.

The inductive charging device according to the invention can consequently be used in the heating state as a resistance heating body, and thereby an additional heating body is superfluous. The heated fluid which is heated by the resistance heating body can be used for example for heating a lubricating oil in a motor, for heating the motor in a cold start, for heating the battery or also for heating an interior of the motor vehicle. The waste heat which is generated in the charging state in the charging coil can be used for preheating a lubricating oil in a motor, for preheating the motor, for preheating the battery or also for preheating an interior of the motor vehicle. For switching the charging device into the charging state and into the heating state, a control device can be provided, for example.

Advantageously, provision can be made that the charging arrangement has a direct current converter. In the heating state, the charging coil is then connected to the battery via the direct current converter in a current-conducting manner. Through the direct current converter, the intensity of the heating direct current can be adapted to the desired heating output of the resistance heating body or respectively of the charging coil.

In order to prevent a short circuit in the inductive charging device, advantageously provision can be made that the charging coil is electrically insulated from the at least one fluid tube of the temperature control arrangement. For this, the fluid tube can have an electrically insulating casing. Alternatively or additionally, the charging coil can also have an electrically insulating casing. Advantageously, the at least one fluid tube of the temperature control arrangement can be made from an electrical insulator and preferably from a plastic. The plastic is then expediently temperature-stable and diffusion-resistant. Additionally, the at least one fluid tube can also have an electrically insulating or sealing coating.

In a further development of the inductive charging device according to the invention, provision is made that the at least one fluid tube of the temperature control arrangement is electrically conductive and is preferably formed from a metal—for example copper or aluminium. In the heating state, the at least one fluid tube of the temperature control arrangement can be connected to the battery in a current-conducting manner, and the heating direct current can flow in the at least one fluid tube of the temperature control arrangement. Alternatively or additionally, in the charging state the at least one fluid tube of the temperature control arrangement can be connected to the battery in a current-conducting manner and the induction alternating current can flow in the at least one fluid tube of the temperature control arrangement. In this way, the at least one fluid tube of the inductive charging device is a part of the inductive charging device, and the heating of the fluid and the charging of the battery can be additionally supported.

Advantageously, provision can be made that the charging coil has at least one stranded current conductor with several current strands, wherein the at least one stranded current conductor is arranged in a heat-transmitting manner on the at least one fluid tube of the temperature control arrangement. The current strands can have a diameter here in which in the current strands in the charging state at a charging frequency between 20 kHz and 140 kHz a skin effect is minimized. In particular, energy losses in the stranded current conductor can be thereby minimized.

Advantageously in this configuration of the stranded current conductor, during the charging the charging state and the heating stand are reached simultaneously in the charging coil. Here, the induction alternating current can flow via some of the current strands, and the heating direct current can flow via the remaining current strands. In this way, the current strands which are flowed through by the heating direct current can also act as a resistance body during the charging. The waste heat which is generated in the current strands which are flowed through by the heating direct current, and the waste heat which is generated in the current strands which are flowed through by the induction alternating current can be used for preheating a lubricating oil in a motor, for preheating the motor, for preheating the battery or also for preheating an interior of the motor vehicle.

The at least one stranded current conductor is arranged in a heat-transmitting manner on the at least one fluid tube of the temperature control arrangement. For this, the current strands of the at least one stranded current conductor can be wound or braided or cabled or woven for example around the at least one fluid tube of the temperature control arrangement. Alternatively thereto, the at least one stranded current conductor can be secured in the at least one fluid tube of the temperature control arrangement along the latter in a manner able to be flowed around by the fluid. The at least one stranded current conductor can be centred in the at least one fluid tube of the temperature control arrangement by a holding device, so that the at least one stranded current conductor is able to be flowed around by the fluid on all sides. The at least one fluid tube then expediently reproduces the shape of the charging coil, so that the stranded current conductor which is arranged along the at least one fluid tube, forms the charging coil. Alternatively, the charging coil formed from the at least one stranded current conductor can be secured in the at least one fluid tube of the temperature control arrangement in a manner able to be flowed around by the fluid. For this, expediently the already formed charging coil is arranged in the at least one fluid tube—which forms here a housing of the charging coil.

Advantageously, provision can be made that the current strands of the at least one stranded current conductor have an electrical conductivity differing from one another. Thus, some of the current strands can consist of copper, aluminium, nickel or iron. In the charging state, the current strands of the at least one stranded current conductor with a higher conductivity—for example of copper or aluminium—can be connected to the battery in a current-conducting manner. The induction alternating current then flows only or preferably via these current strands of the at least one stranded current conductor. Owing to a high conductivity, energy losses in the charging coil are reduced in the charging state. Alternatively or additionally, in the heating state the current strands of the at least one stranded current conductor with a lower conductivity or with a resistance wire—for example of nickel or iron—can be connected to the battery in a current-conducting manner. The heating direct current then flows only or preferably via these current strands of the at least one stranded current conductor. Owing to a low conductivity, energy losses occur in the charging coil, which are transmitted as waste heat to the fluid in the at least one fluid tube of the temperature control arrangement.

Advantageously, during the charging, the charging state and the heating state can be reached simultaneously in the charging coil. Here, the induction alternating current can flow via the current strands with the higher electrical conductivity, and the heating direct current can flow via the current strands with a lower conductivity or via the resistance wire. In this way, the current strands with the lower conductivity of the charging coil can also act as a resistance body during the charging. The waste heat generated in the current strands with the lower conductivity and also the waste heat generated in the current strands with the higher conductivity can be used for preheating a lubricating oil in a motor, for preheating the motor, for preheating the battery or also for preheating an interior of the motor vehicle.

In order to increase the ohmic resistance of the charging coil in the heating state, and thereby also the energy losses, in the heating state the current strands of the at least one stranded current conductor can be connected serially or respectively in series to one another. Here, the length of the current strands flowing through with the heating direct current is increased, and the flow cross-section is reduced. Thereby, the ohmic resistance and accordingly energy losses in the at least one stranded current conductor are increased, which are able to be transmitted as waste heat to the fluid in the at least one fluid tube of the temperature control arrangement. Alternatively or additionally, in the heating state only some of the current strands of the at least one stranded current conductor can be connected to the battery in a current-conducting manner. The heating direct current then flows only via these current strands of the at least one stranded current conductor. The heating output of the charging coil is also able to be adapted with the number of the current strands flowing through by the heating direct current.

In summary, in the inductive charging device according to the invention the charging coil can be used as a resistance heating body, whereby an additional heating body in the motor vehicle is dispensed with. The charging coil and the temperature control arrangement can be configured furthermore multilaterally, so that the maximum heating output is adaptable to the respective motor vehicle. In addition, the heating output of the charging coil can be adapted through the direct current converter, and the charging coil can be used, if required, for heating a lubricating oil in a motor, for heating the motor in a cold start, for heating the battery or also for heating an interior of the motor vehicle.

Further important features and advantages of the invention emerge from the subclaims, from the drawings and from the associated figure description with the aid of the drawings.

It shall be understood that the features mentioned above and to be explained further below are able to be used not only in the respectively indicated combination, but also in other combinations or in isolation, without departing from the scope of the present invention.

Preferred example embodiments of the invention are illustrated in the drawings and are explained further in the following description, wherein the same reference numbers refer to identical or similar or functionally identical components.

### BRIEF DESCRIPTION OF THE DRAWINGS

There are shown, respectively schematically

FIG. 1 a view of an inductive charging device according to the invention in a charging state;

FIG. 2 a view of an inductive charging device according to the invention in a heating state;

FIG. 3 a sectional view of a fluid tube with a stranded current conductor, which is arranged in the fluid tube;

FIG. 4 a sectional view of a fluid tube with a stranded current conductor, the current strands of which are braided around the fluid tube;

FIG. 5 a sectional view of a fluid tube with a charging coil, which is formed from a stranded current conductor and is arranged in the fluid tube.

### DETAILED DESCRIPTION

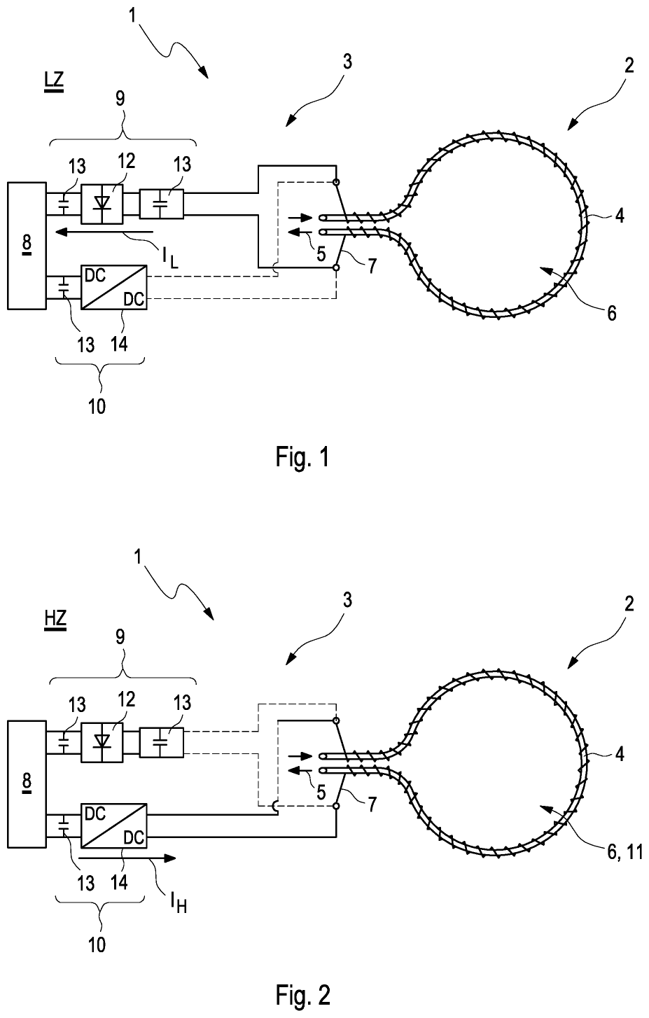

FIG. 1 shows a view of an inductive charging device 1 according to the invention in a charging state LZ. FIG. 2 shows a view of the inductive charging device 1 shown in FIG. 1 in a heating state HZ. The inductive charging device 1 is provided for a motor vehicle and has a temperature control arrangement 2 and a charging arrangement 3. The temperature control arrangement 2 comprises here a fluid tube 4 through which a fluid 5 can flow. The charging arrangement 3 comprises a charging coil 6 with a stranded current conductor 7, and a battery 8. The charging coil 6 is secured to the fluid tube 4 in a heat-transmitting manner, so that the fluid 5 in the fluid tube 4 and the stranded current conductor 7 can exchange heat with one another. Between the charging coil 6 and the battery 8, charging power electronics 9 and heating power electronics 10 are able to be connected in a current-conducting manner. The charging power electronics 9 comprises here a current rectifier 12 and capacitors 13, can however also comprise further elements. The heating power electronics 10 comprises a direct current converter 14 and a capacitor 13, can however also comprise other elements.

The charging coil 6 is formed by the stranded current conductor 7, which is wound several times around the fluid tube 4. In order to prevent a short circuit in the inductive charging device 1, the charging coil 6—therefore the stranded current conductor 7 wound several times around the fluid tube 4—is electrically insulated from the fluid tube 4. For this, the fluid tube 4 can have an electrically insulating casing or also can be produced from an electrical insulator. In addition also the stranded current conductor 7 can have an electrically insulating casing. The fluid tube 4 can also be a part of the charging device, for which the fluid tube 4 can be formed from metal—for example copper or aluminium—and in the charging state LZ and in the heating state HZ is acted upon with an induction alternating current IL or with a heating direct current I_{H}.

In FIG. 1 the charging coil 6 is connected to the battery 8 via the charging power electronics 9 in a current-conducting manner. The battery 8 can be charged inductively and the induction alternating current I_{L} flows in the charging coil 6. The waste heat generated in the charging coil 6 is emitted to the fluid 5 in the fluid tube 4 and can be dissipated to the environment or, however, used for preheating a lubricating oil in a motor, for preheating the motor, for preheating the battery or also for preheating an interior of the motor vehicle. In FIG. 2 the charging coil 6 is connected to the battery 8 via the heating power electronics 10 in a current-conducting manner. The heating direct current hi flows in the charging coil 6, and the charging coil 6 acts as a resistance heating body 11. The high waste heat generated in the charging coil 6 is emitted to the fluid 5 in the fluid tube 4 and can be used for heating a lubricating oil in a motor, for heating the motor in a cold stat, for heating the battery or also for heating an interior of the motor vehicle. Through the direct current converter 14, the heating direct current I_{H} flowing through the charging coil 6 and thereby also the heating output of the charging coil 6 can be adapted. According to the invention, the charging arrangement 3 can be switched into a heating state HZ. For this, a control device can be provided, which is not shown here, however.

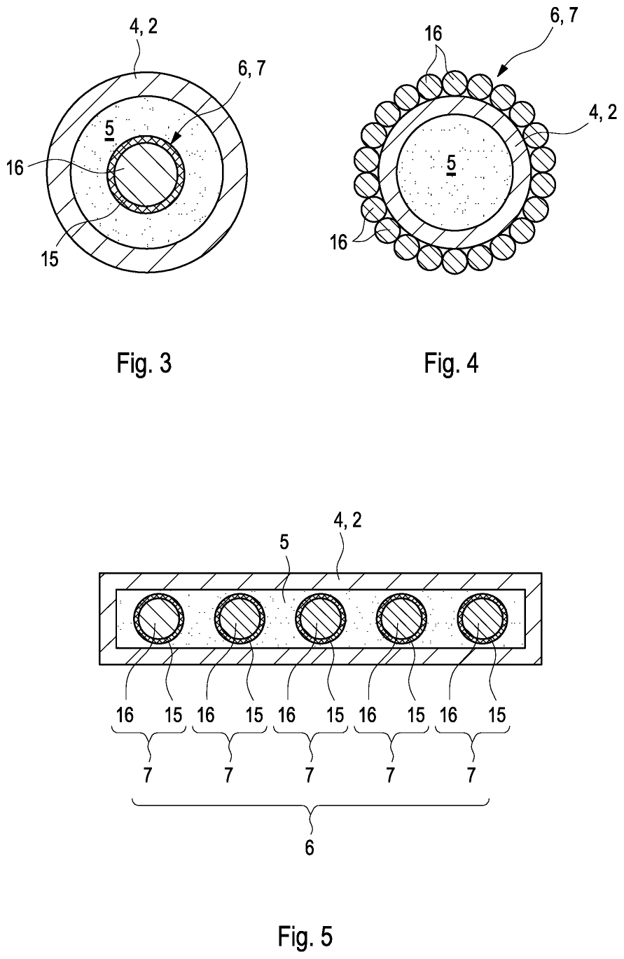

FIG. 3 shows a sectional view of the fluid tube 4 with the stranded current conductor 7, which is arranged in the fluid tube 4. The stranded current conductor 7 has here an electrically insulating casing 15, which electrically insulates current strands 16—here only one—from the fluid 5. Alternatively, the fluid 5 can be electrically non-conducting, so that the electrically insulating casing 15 of the stranded current conductor 7 can be dispensed with. The current strands 16 are dimensioned in such a way that in the charging state LZ at a charging frequency between 20 kHz and 140 kHz a skin effect is minimized. The stranded current conductor 7 in the fluid tube 4 is secured along the latter in a manner able to be flowed around by the fluid 5. The fluid tube 4 then expediently reproduces the shape of the charging coil 6, so that the stranded current conductor 7 arranged along the fluid tube 4 can form the charging coil 6. The waste heat generated in the stranded current conductor 7 is transmitted here directly into the fluid 5.

FIG. 4 shows a sectional view of the fluid tube 4 with the stranded current conductor 7, the current strands 16 of which are braided around the fluid tube 4. The waste heat generated in the current strands 16 is transmitted via the fluid tube 4. In order to reduce losses of the waste heat, the fluid tube 4 can be formed from a heat-conductive material. The current strands 16 are dimensioned in such a way that in the charging state LZ at a charging frequency between 20 kHz and 140 kHz a skin effect is minimized.

FIG. 5 shows a sectional view of the fluid tube 4 with the charging coil 6, which is formed from the stranded current conductor 7 and is arranged in the fluid tube 4. The fluid tube 4 forms here a housing for the charging coil 6. Here also the current strand 16 of the stranded current conductor (7) is dimensioned in such a way that in the charging state LZ at a charging frequency between 20 kHz and 140 kHz a skin effect is minimized.

In summary, in the inductive charging device 1 according to the invention, the charging coil 6 can be used as a resistance heating body 11, so that an additional heating body in the motor vehicle is dispensed with. The charging arrangement 3 is able to be switched into the charging state LZ and into the heating state HZ, so that the charging coil 6, if required, can be used during and also after the charging of the battery 8 in operation of the motor vehicle. The heating output of the charging coil 6 can, in addition, be adapted through the direct current converter 14, and the charging coil 6 can be used, if required, for heating a lubricating oil in a motor, for heating the motor in a cold start, for heating the battery or also for heating an interior of the motor vehicle.

1. An inductive charging device for a partially or fully electrically operated motor vehicle, comprising:
a temperature control arrangement having at least one fluid tube through which fluid can flow, and a charging arrangement including a charging coil and a battery,
the charging coil arranged in a heat-transmitting manner on the at least one fluid tube of the temperature control arrangement, so that the waste heat generated in the charging coil can be transferred to the fluid in the at least one fluid tube of the temperature control arrangement,
wherein in a charging state of the charging arrangement the charging coil is inductively coupled with an external primary coil, and in the charging coil an induction alternating current flows, via which the battery of the charging arrangement is charged,
the charging arrangement can be switched to a heating state, wherein in the heating state the charging coil is connected to the battery in a current-conducting manner, and
in the heating state a heating direct current flows in the charging coil, and the charging coil forms a resistance heating body, wherein the waste heat generated in the charging coil can be transmitted to the fluid in the at least one fluid tube of the temperature control arrangement.

2. The inductive charging device according to claim 1, wherein:
the charging arrangement has a direct current converter, and
in the heating state the charging coil is connected to the battery in a current-conducting manner via the direct current converter.

3. The inductive charging device according to claim 1, wherein the charging coil is electrically insulated from the at least one fluid tube of the temperature control arrangement.

4. The inductive charging device according to claim 1, wherein the at least one fluid tube of the temperature control arrangement is composed of an electrical insulator and preferably from a plastic.

5. The inductive charging device according to claim 1, wherein:
the at least one fluid tube of the temperature control arrangement is electrically conductive and is preferably formed from a metal, and
in at least one of the heating state and the charging state the at least one fluid tube of the temperature control arrangement is connected to the battery in a current-conducting manner, and in the at least one fluid tube of the temperature control arrangement at least one of the heating direct current and the induction alternating current flows.

6. The inductive charging device according to claim 1, wherein the charging coil has at least one stranded current conductor with a plurality of current strands, wherein the at least one stranded current conductor is arranged in a heat-transmitting manner on the at least one fluid tube of the temperature control arrangement.

7. The inductive charging device according to claim 6, wherein the plurality of current strands have a diameter at which in the current strands in the charging state at a charging frequency between 20 kHz and 140 kHz a skin effect is minimized.

8. The inductive charging device according to claim 6, wherein one of:
the plurality of current strands of the at least one stranded current conductor are wound or braided or cabled or woven around the at least one fluid tube of the temperature control arrangement,
the at least one stranded current conductor is secured in the at least one fluid tube of the temperature control arrangement along the temperature control arrangement in a manner able to be flowed around by the fluid, and
the charging coil formed from the at least one stranded current conductor is secured in the at least one fluid tube of the temperature control arrangement in a manner able to be flowed around by the fluid.

9. The inductive charging device according to claim 6, wherein the plurality of current strands of the at least one stranded current conductor have an electrical conductivity differing from one another.

10. The inductive charging device according to claim 9, wherein at least one of:
in the charging state the current strands of the at least one stranded current conductor with a higher conductivity are connected to the battery in a current-conducting manner, and the induction alternating current flows via these current strands of the at least one stranded current converter, and
in the heating state the current strands of the at least one stranded current conductor with a lower conductivity are connected to the battery in a current-conducting manner, and the heating direct current flows via these current strands of the at least one stranded current conductor.

11. The inductive charging device according to claim 6, wherein at least one of:
in the heating state the current strands of the at least one stranded current conductor are connected serially to one another, and
in the heating state only some of the current strands of the at least one stranded current conductor are connected to the battery in a current-conducting manner, and the heating direct current flows only via these current strands of the at least one stranded current conductor.

12. The inductive charging device according to claim 11, wherein the plurality of current strands of the at least one stranded current conductor are wound or braided or cabled or woven around the at least one fluid tube.

13. The inductive charging device according to claim 11, wherein the at least one current conductor is secured in the at least one fluid tube along the temperature control arrangement in a manner able to be flowed around by the fluid.

14. The inductive charging device according to claim 11, wherein the charging coil is secured in the at least one fluid tube in a manner able to be flowed around by the fluid.

15. The inductive charging device according to claim 2, wherein the charging coil is electrically insulated from the at least one fluid tube.

16. The inductive charging device according to claim 15, wherein the at least one fluid tube is composed of an electrical insulator.

17. The inductive charging device according to claim 16, wherein the at least one fluid tube comprises plastic.

18. The inductive charging device according to claim 5, wherein the at least one fluid tube is composed of a metal.

19-20. (canceled)
